(19) United States
(12) Patent Application Publication
(10) Pub. No.: US 2007/0187504 A1
(43) Pub. Date: Aug. 16, 2007

(54) Optical disc

(76) Inventors: Chen Peng, Taipei City (TW); Fung-Hsu Wu, Gueishan Township (TW); William Wai Wang, Taoyuan City (TW); Bow-Yi Jang, Taichung City (TW); Lin Hsiao, Taoyuan City (TW); Ta-Yuan Lee, Linkou Township (TW); Yao-Wen Chang, Fongshan City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/417,957

(22) Filed: May 4, 2006

(30) Foreign Application Priority Data
Feb. 10, 2006 (TW) 095104462

(51) Int. Cl. G06K 7/10

(52) U.S. Cl. 235/454

(57) ABSTRACT

The present invention provides an optical disk and, more particularly, an optical disk including a data side and a label side. The data side has a first pregroove on which a plurality of first position marks are marked to provide an optical pickup unit with a basis for writing data onto the data side or reading data from the data side. In addition, the label side has a label layer and a second pregroove on which a plurality of second position marks are marked to provide the optical pickup unit with a basis for forming an image onto the label side.

### BACKGROUND OF THE INVENTION

1. Field of the Invention

The invention relates to an optical disc and, more particularly, to an optical disc capable of forming an image on its label side by means of a laser beam.

2. Description of the Prior Art

A prevailing strategy to write data onto the data side of a variety of optical discs is to previously form a pregroove on the data side of the optical discs. Predetermined address codes, such as Absolute Time In Pregroove codes (ATIP codes), are marked on the pregroove to provide an optical information recording/reproducing apparatus with a basis for writing data onto the data side or reading data from the data side. In sum, when an optical drive is instructed to perform data-reading and data-writing, the ATIP codes are read to seek a specified section, thus simplifying the process of positioning the data side of an optical disc.

With respect to the prior art regarding the pregroove applied to optical discs and the strategy of storing or reading ATIP codes, please refer to U.S. Pat. No. 5,226,027 and the book, “Compact Disc Recordable System Description” (Third Edition), which is published by Phillips International, Inc. in 1997. The detail of this technique is not described herein.

As it is more and more popular to use optical discs to store data, a problem that follows is how to manage the optical discs in which data has been stored. As consumers hope to identify the data recorded in their own optical discs with more effective ways, many methods to label the non-data side of the optical discs are continuously developed in various forms, such as in text and figures. The basic methods for labeling an optical disc include writing down something on the label side of the optical disc with a permanent marker, such as a sharpie marker, or printing out a paper sticker label and sticking it on the non-data side of the optical disc. Other conventional labeling methods performed in an optical disc player include using ink jet (referring to what is disclosed by Compulog Corporation, in U.S. Pat. No. 6,074,031), thermal wax transfer, thermal dye transfer, and so forth.

A critical problem of automatically labeling an optical disc is that the label side (non-data side) of the optical disc has neither aforementioned pregrooves nor predetermined address codes, such as ATIP codes, so that it is difficult to label marks on the label side of the optical disc.

In recent years, several techniques related to creating patterns on the label layer of an optical disc have been proposed, such as a technique known as the LightScribe technique and disclosed in U.S. Pat. No. 6,864,907 by Hewlett-Packard Development Company, L.P. The technique is to provide an optical disc with a label side having a color that changes in response to radiation or heat. Moreover, the label side is disposed to face an optical pickup, from which a laser beam is emitted to make the label side change its color to form a visible image, which is the information to identify the optical disc. A group of alignment marks are pre-printed on the label side in order to position the image to be printed.

However, owing to the characteristics of the material of the label side, so far there is no available method for an optical information recording/reproducing apparatus to determine which location on the label side of the optical disc has already been marked. When images are repeatedly printed on the label side of the optical disc, new images will unavoidably cover previously recorded images. In addition, because the number of alignment marks on the label side is limited, the optical information recording/reproducing apparatus spends more time to position the alignment marks, thus extending the time for forming images onto the label side.

### SUMMARY OF THE INVENTION

A scope of this invention is to provide an optical disc capable of forming an image onto its label side by means of a laser beam and maintaining the usage status of its label side. When images are repeatedly printed on the label side of the optical disc, the optical disc can keep a new image from covering a previously recorded image. In addition, the optical disc can effectively shorten the positioning time of the optical information recording/reproducing apparatus, thus improving the efficiency of forming an image onto the label side.

According to a preferred embodiment of this invention, an optical disc includes a data side and a label side. The data side has a first pregroove on which a plurality of first position marks is previously marked to provide an optical pickup unit with a basis for to writing data onto the data side or reading data from the data side. On the other hand, the label side has a label layer and a second pregroove on which a plurality of second position marks is previously marked to provide the optical pickup unit with a basis for forming an image onto the label side.

The advantage and spirit of the invention may be understood by the following recitations together with the appended drawings.

### BRIEF DESCRIPTION OF THE APPENDED DRAWINGS

FIG. 1 is a portion of a cross-sectional view illustrating the structure of an optical disc according to a preferred embodiment of the invention.

FIG. 2 is a portion of a cross-sectional view illustrating the structure of an optical disc according to another preferred embodiment of the invention.

### DETAILED DESCRIPTION OF THE INVENTION

The present invention provides an optical disc and, more particularly, an optical disc capable of forming an image onto its label side by means of a laser beam and preserving the status of its label side.

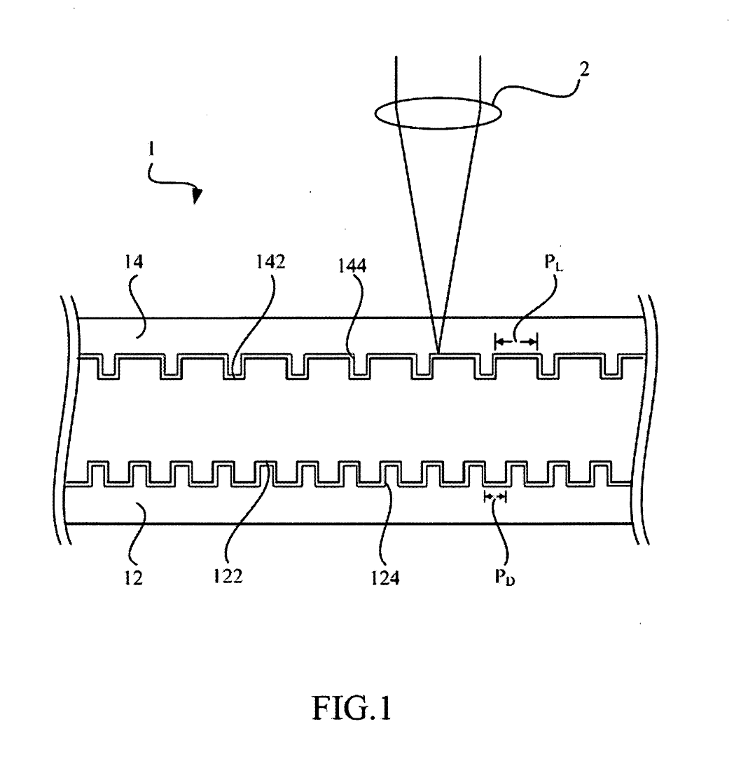

Referring to FIG. 1, FIG. 1 is a portion of a cross-sectional view illustrating the structure of an optical disc 1 according to a preferred embodiment of the invention. The optical disc includes a data side 12 and a label side 14. The data side 12 has a first pregroove 122 on which a plurality of first position marks are previously marked to provide an optical pickup unit 2 with a basis for writing data onto the data side 12 or reading data from the data side 12. In addition, the label side 14 has a label layer 144 and a second pregroove 142 on which a plurality of second position marks are previously marked to provide the optical pickup unit 2 or other optical pickup units with a basis for forming an image onto the label side 14.

Similarly, referring to the embodiment in FIG. 1, the label layer 144 is formed of a dye and covers the second pregroove 142. The label layer 144 is used to provide the optical pickup unit with a basis for forming the image onto the label side 14 and for reading this image thereon. Furthermore, the data side 12 also has a data layer 124 which is formed of a dye or a phase change material, and it covers the first pregroove 122. Moreover, the data layer 124 provides the optical pickup unit with a basis for writing data onto the data side or reading data from the data side.

In practical applications, the plurality of second position marks are marked to provide the optical pickup unit with a basis for reading the image formed on the label side. When the optical pickup unit is instructed to form the image, the plurality of second position marks are read to seek a specified section, so as to shorten the positioning time on the label layer 14 for the optical pickup unit. In practice, the second position marks are ATIP codes, which are stated in the aforementioned book, “Compact Disc Recordable System Description” (Third Edition).

In practical applications, the dye forming the label layer 144 is a thermally-sensitive dye, which changes its color when heated. Therefore, when the label layer 144 senses the heat of a laser beam emitted by the optical pickup unit, it is able to change its original color into other colors, such as grey, black, or any other color desired.

In addition, as shown the embodiment in FIG. 1, the pitch PL between the second pregrooves 142 of the label side 14 is longer than the pitch PD between the first pregrooves 122 of the data side 12. In other words, the data side 12 (including the first pregroove 122 and the first position marks) can be configured to comply with a DVD-R specification or a DVD+R specification, so as to provide the optical pickup unit with a basis for writing data onto or reading data from the data side 12. Because the density of the position marks needed for the optical pickup unit to position the label side 14 is relatively low, the density of the second pregroove 142 and the second position marks of the label side 14 is lower than that of the first pregroove 122 and the first position marks of the data side 12.

Obviously, through the second pregroove 142 of the label side 14 and a plurality of second position marks marked on the second pregroove 142, the optical disc 1 can maintain the usage status of its label side and can keep a new image from covering a previously recorded image when images are repeatedly printed on the label side 14 of the optical disc. Moreover, the speed of forming the image on the label side 14 by means of the optical pickup unit will be also prominently accelerated.

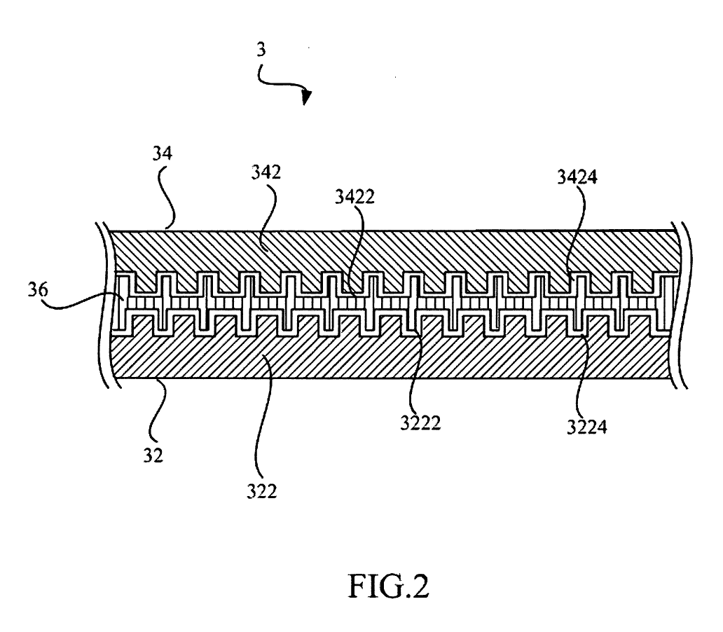

Referring to FIG. 2, FIG. 2 is a portion of a cross-sectional view illustrating the structure of an optical disc 3 according to another preferred embodiment of the invention. The optical disc 3 includes a first substrate 32 and a second substrate 34. The first substrate 32 is made of a first layer 322, which has a first tracked surface 3222, and an information layer 3224 located on one side of the first tracked surface. Moreover, the second substrate 34 is made of a second layer 342, which has a second tracked surface 3422, and a coloring layer 3424 of a thermally-sensitive dye covering the second tracked surface. The second substrate 34 adheres to the first substrate 32 by means of an adhesive substance 36.

In an embodiment, the coloring layer is formed of a thermally-sensitive dye, and it covers the second tracked surface. Moreover, the data layer is formed of a dye or a phase change material, and it covers the first tracked surface. The data layer is configured to configured to comply with a DVD-R specification or a DVD+R specification.

In practical applications, the first tracked surface provides an optical pickup unit with a basis for writing data onto the data side or reading data from the data side. The second tracked surface provides the optical pickup unit with a basis for forming or reading an image on the coloring layer.

Obviously, through the second tracked surface of the second layer, the optical disc can maintain its usage status and can keep a new image from covering a previously recorded image when images are repeatedly printed on the coloring layer of the optical disc. Moreover, the speed of forming the image on the coloring layer by using the optical pickup unit will be also prominently accelerated.

With the recitations of the preferred embodiments above, the features and spirits of the invention will be hopefully well described, but the scope of the invention will not be constrained. However, the objective is expected to cover all alternative and equivalent arrangements in the scope of the appended claims for which the invention apply.

What is claimed is:

1. An optical disc, comprising:
a data side having a first pregroove on which a plurality of first position marks are marked to provide an optical pickup unit with a basis for writing data onto the data side or reading data from the data side; and
a label side having a label layer and a second pregroove on which a plurality of second position marks are marked to provide the optical pickup unit with a basis for forming an image onto the label side.

2. The optical disc of claim 1, wherein the data side has a data layer formed of a dye or a phase change material, and covering the first pregroove.

3. The optical disc of claim 2, wherein the label layer is formed of a dye and covers the second pregroove.

4. The optical disc of claim 3, wherein the pitch of the second pregroove is longer than the pitch of the second pregroove.

5. The optical disc of claim 4, wherein the plurality of second position marks also provide the optical pickup unit with a basis for reading the image formed on the label side.

6. The optical disc of claim 5, wherein the data side is configured to comply with a DVD-R specification or a DVD+R specification.

7. An optical disc, comprising:
a first substrate made of a first layer, said first layer having a first tracked surface and an information layer located in one side of the first tracked surface; and
a second substrate consisting of a second layer, said second layer having a second tracked surface and a coloring layer of a thermally-sensitive dye which covers the second tracked surface, said second substrate adhering to the first substrate.

8. The optical disc of claim 7, wherein the information layer is formed of a dye or a phase change material and covers the first tracked surface.

9. The optical disc of claim 8, wherein the information layer is configured to comply with a DVD-R specification or a DVD+R specification.
